(19) United States
(12) Patent Application Publication
(10) Pub. No.: US 2014/0045047 A1
(43) Pub. Date: Feb. 13, 2014

(54) NONAQUEOUS ELECTROLYTE SECONDARY BATTERY

(71) Applicant: SANYO Electric Co., Ltd., Osaka (JP)

(72) Inventors: Yoshinori Yokoyama, Itano-gun (JP); Takayuki Hattori, Minamiawaji-shi (JP); Yasuhiro Yamauchi, Sumoto-shi (JP)

(73) Assignee: SANYO ELECTRIC CO., LTD., Osaka (JP)

(21) Appl. No.: 13/962,502

(22) Filed: Aug. 8, 2013

(30) Foreign Application Priority Data
Aug. 9, 2012 (JP) 2012-176791

(51) Int. Cl. H01M 10/04

(52) U.S. Cl. CPC H01M 10/0431
USPC 429/178

(57) ABSTRACT

A nonaqueous electrolyte secondary battery includes an electrode assembly, a nonaqueous electrolyte, a container, and a collector material. The electrode assembly includes a positive electrode, a negative electrode, and a separator. The negative electrode is opposed to the positive electrode. The separator is disposed between the positive electrode and the negative electrode. The nonaqueous electrolyte contains lithium bis(oxalato)borate (LiBOB). The container houses the electrode assembly and the nonaqueous electrolyte, and is provided with terminals. The collector material connects the terminals to the electrode assembly. The cross-sectional area of the collector material is not less than 1.5 mm².

### TECHNICAL FIELD

The present invention relates to a nonaqueous electrolyte secondary battery.

### BACKGROUND ART

In recent years, there have been various endeavors to use nonaqueous electrolyte secondary batteries in, for example, electric vehicles, hybrid cars, and the like. In such applications, the batteries are strongly required to have long life in addition to high output.

For example, JP-A-2009-245828 states that the cycling life of a nonaqueous electrolyte secondary battery is improved by adding lithium bis(oxalato)borate (LiBOB) to its nonaqueous electrolyte.

The inventors of the present invention have discovered, as a result of diligent researches, that although the cycling life of nonaqueous electrolyte secondary batteries is improved when LiBOB is added to their nonaqueous electrolyte, the battery interior will be prone to heat up, in the event of trouble such as the battery being crushed due to impact from the exterior. The inventors have arrived at the invention as a result of this discovery.

### SUMMARY

A principal advantage of some aspects of the invention is to provide a nonaqueous electrolyte secondary battery in which heating-up of the battery interior is prevented even in the event of a trouble as above.

A nonaqueous electrolyte secondary battery of an aspect of the invention includes an electrode assembly, a nonaqueous electrolyte, a container, and a collector material. The electrode assembly includes a positive electrode, a negative electrode, and a separator. The negative electrode is opposed to the positive electrode. The separator is disposed between the positive electrode and the negative electrode. The nonaqueous electrolyte contains lithium bis(oxalato)borate (LiBOB). The container houses the electrode assembly and the nonaqueous electrolyte. The container is provided with a terminal. The collector material connects the terminal to the electrode assembly. The cross-sectional area of the collector material is not less than 1.5 mm².

The invention can provide a nonaqueous electrolyte secondary battery in which the battery interior will not be prone to heat up in the event of trouble such as the battery being crushed due to impact from the exterior.

### BRIEF DESCRIPTION OF THE DRAWINGS

The invention will be described with reference to the accompanying drawings, wherein like numbers reference like elements.

FIG. 1 is a simplified perspective view of a nonaqueous electrolyte secondary battery according to an embodiment of the invention.

FIG. 2 is a simplified sectional view through line II-II in FIG. 1.

FIG. 3 is a simplified sectional view through line III-III in FIG. 1.

FIG. 4 is a simplified sectional view through line IV-IV in FIG. 1.

FIG. 5 is a simplified sectional view of part of the electrode assembly in an embodiment of the invention.

FIG. 6 is a schematic perspective view of a collector material in the embodiment of the invention.

### DESCRIPTION OF EXEMPLARY EMBODIMENTS

A preferred embodiment that implements the invention will now be described with reference to the accompanying drawings. However, the following embodiment is merely an illustrative example and does not limit the invention in any way.

In the accompanying drawings, to which reference will be made in describing the embodiment and other matters, members that have substantially the same functions are assigned the same reference numerals throughout. In addition, the accompanying drawings, to which reference will be made in describing the embodiment and other matters, are schematic representations, and the proportions of the dimensions of the objects depicted in the drawings may differ from the proportions of the dimensions of the actual objects. The proportions of the dimensions of the objects may differ among the drawings. The concrete proportions of the dimensions of the objects should be determined in view of the following description.

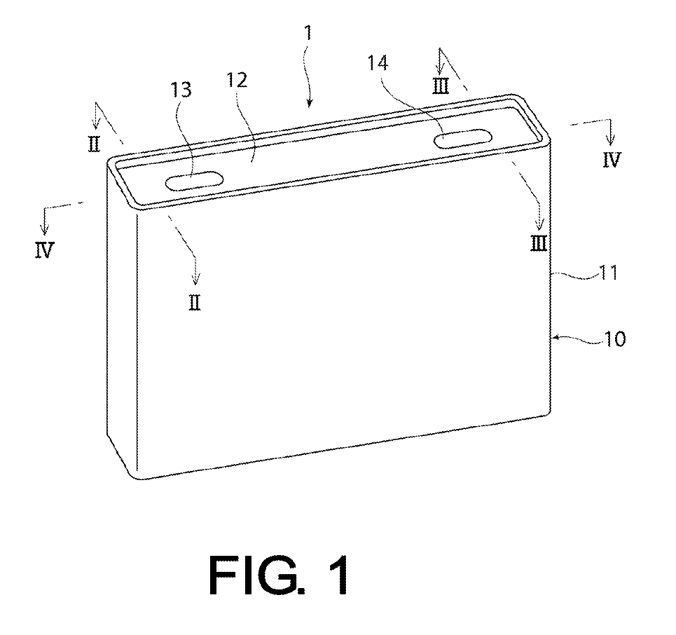

A nonaqueous electrolyte secondary battery 1 shown in FIG. 1 is a prismatic nonaqueous electrolyte secondary battery. The nonaqueous electrolyte secondary battery 1 can be used for any kind of application, and will preferably be used in an electric vehicle and a hybrid vehicle, for example. Normally, the capacity of the nonaqueous electrolyte secondary battery 1 will be 5 to 50 Ah.

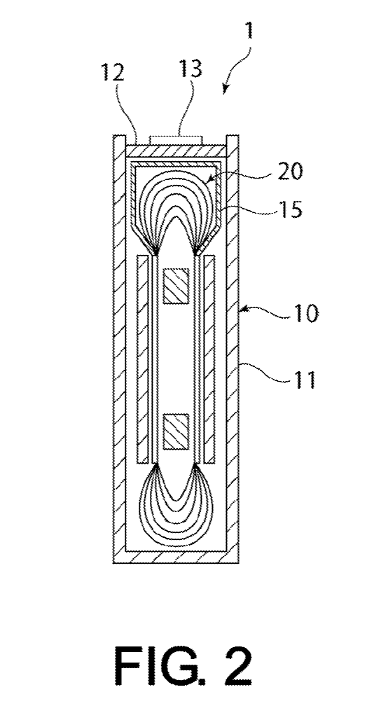

The nonaqueous electrolyte secondary battery 1 includes a container 10 shown in FIGS. 1 to 4, and an electrode assembly 20 shown in FIGS. 2 to 5.

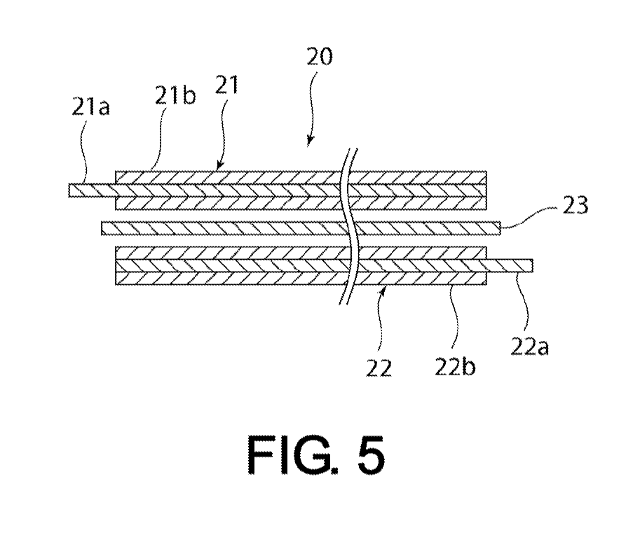

As shown in FIG. 5, the electrode assembly 20 includes the positive electrode 21, the negative electrode 22, and a separator 23. The positive electrode 21 and the negative electrode 22 are opposed to each other. The separator 23 is disposed between the positive electrode 21 and the negative electrode 22. The positive electrode 21, the negative electrode 22, and the separator 23 are wound and then pressed into a flattened shape. In other words, the electrode assembly 20 includes a flat wound positive electrode 21, negative electrode 22, and separator 23.

The positive electrode 21 includes a positive electrode substrate 21a and a positive electrode active material layer 21b. The positive electrode substrate 21a can be formed of aluminum, an aluminum alloy, or other materials. The thickness of the positive electrode substrate 21a will preferably be on the order of 0.5 to 1.5 mm, and further preferably will be on the order of 0.6 to 1.0 mm, for example. The positive electrode active material layer 21b is provided on at least one surface of the positive electrode substrate 21a. The positive electrode active material layer 21b contains a positive electrode active material. An example of the positive electrode active material that will preferably be used is a lithium oxide containing at least one of cobalt, nickel, and manganese. The following shows specific examples of such a lithium oxide containing at least one of cobalt, nickel, and manganese: lithium-containing nickel-cobalt-manganese complex oxides (LiNiₓCo_{y}Mn_{z}O₂, x+y+z=1, 0≦x≦1, 0≦y≦1, 0≦z≦1); lithium cobalt oxide (LiCoO₂); lithium manganese oxide (LiMn₂O₄); lithium nickel oxide (LiNiO₂); and a lithium-containing transition metal complex oxide such as a compound obtained by replacing part of the transition metal contained in these oxides with another element. Of these, lithium-containing nickel-cobalt-manganese complex oxides (LiNiₓCo_{y}Mn_{z}O₂, x+y+z=1, 0≦x≦1, 0≦y≦1, 0≦z≦1) and a lithium-containing transition metal complex oxide such as a compound obtained by replacing part of the transition metal contained in such oxide with another element will further preferably be used as the positive electrode active material. The positive electrode active material layer 21b may contain another component such as conductive material and binder as appropriate in addition to the positive electrode active material.

The negative electrode 22 includes a negative electrode substrate 22a and a negative electrode active material layer 22b. The negative electrode substrate 22a can be formed of copper, a copper alloy, or other materials. The thickness of the negative electrode substrate 22a will preferably be on the order of 0.5 to 1.5 mm, and further preferably will be on the order of 0.6 to 1.0 mm, for example. The negative electrode active material layer 22b is provided on at least one surface of the negative electrode substrate 22a. The negative electrode substrate 22a contains negative electrode active material. There is no particular limitation on the negative electrode active material, provided that it is able to reversibly absorb and desorb lithium. Examples of the negative electrode active material that will preferably be used are: carbon material, material that alloys with lithium, and metal oxide such as tin oxide. The following specific examples of carbon material can be cited: natural graphite, artificial graphite, mesophase pitch-based carbon fiber (MCF), mesocarbon microbeads (MCMB), coke, hard carbon, fullerene, and carbon nanotubes. Examples of material that can alloy with lithium are: one or more metals selected from the group consisting of silicon, germanium, tin, and aluminum, or an alloy containing one or more metals selected from the group consisting of silicon, germanium, tin, and aluminum. Of these, natural graphite, artificial graphite, and mesophase pitch-based carbon fiber (MCF) will preferably be used as the negative electrode active material. The negative electrode active material layer 22b may contain another component such as conductive material and binder as appropriate in addition to the negative electrode active material.

The separator can be formed of a porous sheet of plastic such as polyethylene and polypropylene.

The electrode assembly 20 is housed inside the container 10. The nonaqueous electrolyte is also housed inside the container 10. The nonaqueous electrolyte contains lithium bis(oxalato)borate (LiBOB) as solute. The content of LiBOB in the nonaqueous electrolyte will preferably be 0.05 to 0.20 mol/L, and further preferably 0.10 to 0.18 mol/L. The preferable content range for LiBOB is based on the nonaqueous electrolyte in the nonaqueous electrolyte secondary battery immediately after assembly and before the first charging. The reason for providing such basis is that when a nonaqueous electrolyte secondary battery containing LiBOB is charged, its content level gradually declines.

In addition to LiBOB, the nonaqueous electrolyte may contain as solute a substance such as: LiXF_{y} (where X is P, As, Sb, B, Bi, Al, Ga, or In, and y is 6 when X is P, As, or Sb, and y is 4 when X is B, Bi, Al, Ga, or In); lithium perfluoroalkyl sulfonic acid imide LiN(CₘF₂ₘ₊₁SO₂)(CₙF₂ₙ₊₁SO₂) (where m and n are independently integers from 1 to 4); lithium perfluoroalkyl sulfonic acid methide LiC(CₚF₂ₚ₊₁SO₂)(C_{q}F_{2q+1}SO₂)(CᵣF₂ᵣ₊₁SO₂) (where p, q, and r are independently integers from 1 to 4); LiCF₃SO₃; LiClO₄; Li₂B₁₀Cl₁₀; and Li₂B₁₂Cl₁₂. Of these, the nonaqueous electrolyte may contain, as solute, at least one of LiPF₆, LiBF₄, LiN(CF₃SO₂)₂, LiN(C₂F₅SO₂)₂, LiN(CF₃SO₂)(C₄F₉SO₂), LiC(CF₃SO₂)₃, and LiC(C₂F₅SO₂)₃, for example. The nonaqueous electrolyte may contain as solvent, for example, cyclic carbonate, chain carbonate, or a mixture of cyclic carbonate and chain carbonate. Specific examples of cyclic carbonate are ethylene carbonate, propylene carbonate, butylene carbonate, and vinylene carbonate. Specific examples of chain carbonate are dimethyl carbonate, methylethyl carbonate, and diethyl carbonate.

The container 10 has a container body 11 and a sealing plate 12. The container body 11 is provided in the form of a rectangular tube of which one end is closed. The container body 11 has an opening. This opening is sealed up by the sealing plate 12. Thereby, the parallelepiped interior space is formed into a compartment. The electrode assembly 20 and the nonaqueous electrolyte are housed in this interior space.

A positive electrode terminal 13 and a negative electrode terminal 14 are connected to the sealing plate 12. The positive electrode terminal 13 and the negative electrode terminal 14 are each electrically insulated from the sealing plate 12 by insulating material not shown in the drawings.

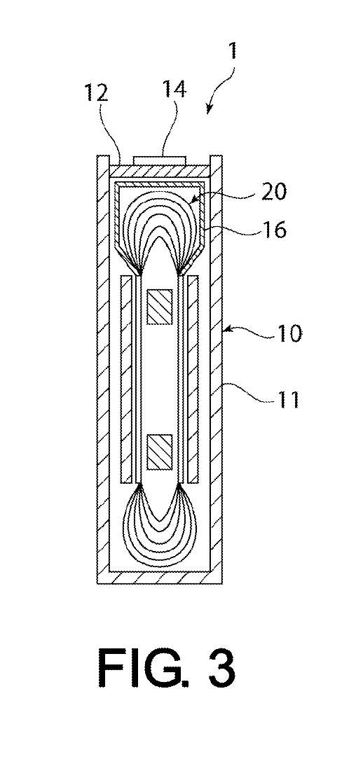

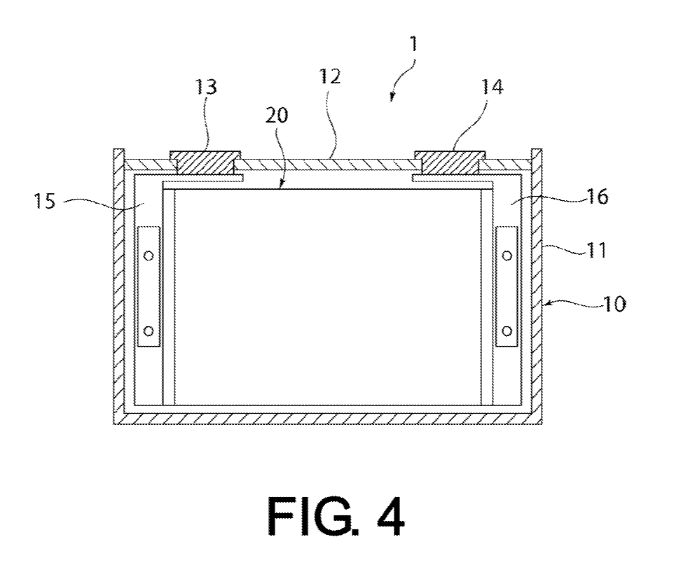

As shown in FIGS. 2 and 4, the positive electrode terminal 13 is electrically connected to a positive electrode substrate 21a of a positive electrode 21 by positive electrode collector 15. The positive electrode collector 15 can be formed of aluminum, an aluminum alloy, or other materials. As shown in FIGS. 2 and 3, the negative electrode terminal 14 is electrically connected to a negative electrode substrate 22a of a negative electrode 22 by negative electrode collector 16. The negative electrode collector 16 can be formed of copper, a copper alloy, or other materials.

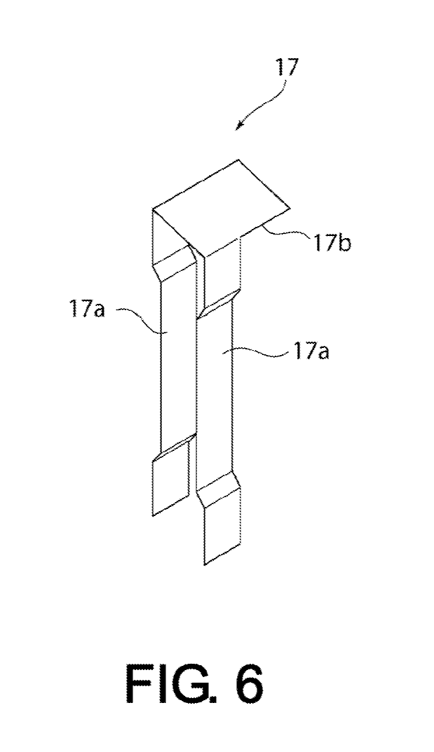

The positive electrode collector 15 and the negative electrode collector 16 can be formed using a collector material 17 shown in FIG. 6, for example. The collector material 17 has at least one first piece 17a and a second piece 17b. The first piece 17a is electrically connected to the positive electrode 21 or the negative electrode 22 through being joined to the positive electrode substrate 21a or the negative electrode substrate 22a, by means of welding or other methods. In this negative embodiment, two first pieces 17a are provided, and the electrode assembly 20 is held by these two first pieces 17a.

The first piece 17a is electrically connected to the second piece 17b. The second piece 17b is disposed between the electrode assembly 20 and the sealing plate 12. The second piece 17b is electrically connected to the positive electrode terminal 13 or the negative electrode terminal 14. Specifically, the second piece 17b of the collector material 17 forming the positive electrode collector 15 is electrically connected to the positive electrode terminal 13, and the second piece 17b of the collector material 17 forming the negative electrode collector 16 is electrically connected to the negative electrode terminal 14.

The cross-sectional area of the collector material is determined as appropriate according to the battery capacity and other factors of the nonaqueous electrolyte secondary battery. Normally the cross-sectional area of the collector material will be determined at a value such that no great electricity loss will occur due to the collector material. From this point of view, it is considered preferable that the cross-sectional area of the collector material be amply large. However, if the cross-sectional area of the collector material is made too large, the collector material will become large-size and moreover will become heavy. As a result, the nonaqueous electrolyte secondary battery will become large-size and also heavy. Hence, the collector material is determined at as thin and small-size as possible within the range in which no great electricity loss will occur due to the collector material.

In cases where the battery capacity is 5 to 50 Ah, as for example in the nonaqueous electrolyte secondary battery 1 of this embodiment, generally a cross-sectional area of the collector material is on the order of 1.5 to 10 mm².

As stated above, the nonaqueous electrolyte in the nonaqueous electrolyte secondary battery 1 contains LiBOB. Thanks to this, improved cycling life can be realized. However, the inventors have discovered, as a result of diligent researches, that in nonaqueous electrolyte secondary batteries with a nonaqueous electrolyte containing LiBOB, the battery interior will be prone to heat up in the event of trouble such as the battery being crushed due to impact from the exterior. The cause of this is surmised to be that during a trouble such as the aforementioned, the electrode assembly 20 is heated, and when it exceeds a certain temperature, reaction products derived from the LiBOB give rise to new exothermic reactions. Now, with the nonaqueous electrolyte secondary battery 1, the cross-sectional area of the collector material 17 (precisely, the cross-sectional area of the thinnest portion of the connecting portion of the collector material 17, which connects the portion connected to the positive and negative electrode substrate 21a or 22a and the portion connected to the terminal 13 or 14, respectively) is not less than 1.5 mm². Thanks to this, the heat of the electrode assembly 20 is readily dissipated via the collector material 17 and the container 10. Thus, during a trouble such as the aforementioned, temperature rise of the electrode assembly 20 will be prevented in the nonaqueous electrolyte secondary battery 1, and so the exothermic reactions that would result from such temperature rise can be avoided.

In the interest of further preventing the nonaqueous electrolyte secondary battery 1 from heating up, the cross-sectional area of the collector material 17 will preferably be not less than 1.5 mm², and further preferably will be not less than 3.0 mm². However, if the cross-sectional area of the collector material 17 is too large, the nonaqueous electrolyte secondary battery 1 may be too large in size or the weight of the nonaqueous electrolyte secondary battery 1 may increase too much. Hence, the cross-sectional area of the collector material 17 will preferably be not more than 10 mm², and further preferably will be not more than 7 mm². Similarly, the thickness of the collector material 17 will preferably be not less than 0.5 mm, and further preferably will be not less than 0.6 mm. The thickness of the collector material 17 will preferably be not more than 1.5 mm, and further preferably will be not more than 1.0 mm.

In the interest of further preventing the nonaqueous electrolyte secondary battery 1 from heating up, the thermal conductivity of the collector material 17 will preferably be not less than 150 W/m·k, and further preferably will be not less than 200 W/m·k.

Furthermore, with the above structure, when the nonaqueous electrolyte secondary battery 1 is exposed to a low-temperature environment, the battery interior temperature will be prone to fall, and so the output characteristics will decline. To prevent decline of the output characteristics also in low-temperature environments, the nonaqueous electrolyte will preferably contain lithium difluorophosphate. The content of lithium difluorophosphate in the nonaqueous electrolyte will preferably be 0.01 to 0.20 mol/L, and further preferably will be 0.03 to 0.10 mol/L. These preferable content ranges for the lithium difluorophosphate are standard values for the nonaqueous electrolyte in the nonaqueous electrolyte secondary battery immediately after assembly and before the first charging. The reason for providing such standard values is that when a nonaqueous electrolyte secondary battery containing lithium difluorophosphate is charged, the content level gradually declines.

It will suffice for LiBOB to be present in the electrolyte immediately after the nonaqueous electrolyte secondary battery has been assembled. For example, after charge-discharge has been performed following assembly, the LiBOB may in some cases be present in the form of a LiBOB alteration. In other cases, at least a part of the LiBOB or the LiBOB alteration may be present on the negative electrode active material layer. Such cases are included in the technical scope of the invention.

What is claimed is:

1. A nonaqueous electrolyte secondary battery, comprising:
an electrode assembly including a positive electrode, a negative electrode opposed to the positive electrode, and a separator disposed between the positive electrode and the negative electrode;
a nonaqueous electrolyte containing lithium bis(oxalato)borate (LiBOB);
a container housing the electrode assembly and the nonaqueous electrolyte, and provided with a terminal; and
a collector material connecting the terminal and the electrode assembly,
the cross-sectional area of the collector material being not less than 1.5 mm².

2. The nonaqueous electrolyte secondary battery according to claim 1, wherein the thermal conductivity of the collector material is not less than 150 W/m·k.

3. The nonaqueous electrolyte secondary battery according to claim 1, wherein the thickness of the collector material is not less than 0.5 mm.

4. The nonaqueous electrolyte secondary battery according to claim 2, wherein the thickness of the collector material is not less than 0.5 mm.

5. The nonaqueous electrolyte secondary battery according to claim 1, wherein the capacity of the battery is 5 to 40 Ah.

6. The nonaqueous electrolyte secondary battery according to claim 2, wherein the capacity of the battery is 5 to 40 Ah.

7. The nonaqueous electrolyte secondary battery according to claim 3, wherein the capacity of the battery is 5 to 40 Ah.

8. The nonaqueous electrolyte secondary battery according to claim 4, wherein the capacity of the battery is 5 to 40 Ah.

9. The nonaqueous electrolyte secondary battery according to claim 1, wherein the nonaqueous electrolyte contains lithium diflorophosphate.

10. The nonaqueous electrolyte secondary battery according to claim 2, wherein the nonaqueous electrolyte contains lithium difluorophosphate.

11. The nonaqueous electrolyte secondary battery according to claim 3, wherein the nonaqueous electrolyte contains lithium difluorophosphate.

12. The nonaqueous electrolyte secondary battery according to claim 4, wherein the nonaqueous electrolyte contains lithium difluorophosphate.

13. The nonaqueous electrolyte secondary battery according to claim 5, wherein the nonaqueous electrolyte contains lithium difluorophosphate.

14. The nonaqueous electrolyte secondary battery according to claim 6, wherein the nonaqueous electrolyte contains lithium difluorophosphate.

15. The nonaqueous electrolyte secondary battery according to claim 7, wherein the nonaqueous electrolyte contains lithium difluorophosphate.

16. The nonaqueous electrolyte secondary battery according to claim 8, wherein the nonaqueous electrolyte contains lithium difluorophosphate.
